(19) United States
(12) Patent Application Publication
(10) Pub. No.: US 2024/0169784 A1
(43) Pub. Date: May 23, 2024

(54) GIFT BOX SYSTEM AND METHOD

(71) Applicant: Send A Cake LLC, Bellevue, WA (US)

(72) Inventor: James T. Siew, Bellevue, WA (US)

(21) Appl. No.: 18/511,389

(22) Filed: Nov. 16, 2023

Related U.S. Application Data
(63) Continuation-in-part of application No. 29/860,818, filed on Nov. 22, 2022.
(60) Provisional application No. 63/427,394, filed on Nov. 22, 2022.

(51) Int. Cl. G07D 11/13; G07D 11/14

(52) U.S. Cl. CPC G07D 11/13; G07D 11/14; G07D 2211/00

(57) ABSTRACT

A box that includes flaps coupled at a top end and a shooter system. The shooter system comprises a stack of a plurality of sheets disposed within a sheet cavity, a roller actuation assembly that comprises a roller that contacts the stack of the plurality of sheets and an actuating button. Actuating the actuating button causes the first and second flaps to be released from a closed configuration and open to an open configuration. Actuating the actuating button further causes the roller to spin, which in turn causes the plurality of stacked sheets to be ejected from the sheet cavity through a slot defined by the shooter system, the plurality of stacked sheets ejected between the first and second flaps in the open configuration.

### CROSS-REFERENCE TO RELATED APPLICATIONS

This application is a non-provisional of and claims priority to U.S. Provisional Application No. 63/427,394, filed Nov. 22, 2022, entitled “GIFT BOX SYSTEM AND METHOD,” with attorney docket number 0116247-004PRO. This application is hereby incorporated herein by reference in its entirety and for all purposes.

This application is related to and claims priority to U.S. Design Application No. 29/860,818, filed Nov. 22, 2022, entitled “GIFT BOX,” with attorney docket number 0116247-003US0. This application is hereby incorporated herein by reference in its entirety and for all purposes.

### BRIEF DESCRIPTION OF THE DRAWINGS

FIG. 1 illustrates an example of operating a surprise money box where the box is in a first configuration after a user presses an actuating button with their finger.

FIG. 2 illustrates the surprise money box in a second configuration after the user has actuated the actuating button, where the pair of flaps on the top of the surprise money box rotate upward to expose an internal cavity of the surprise money box that includes an internal box and a shooter system.

FIG. 3 illustrates a third configuration of the surprise money box after the user has actuated the actuating button where the shooter system has been actuated via the actuating button, which causes a plurality of bills loaded in the shooter system to shoot out of the shooter system through the slot, between the open flaps, and into the air above the surprise money box.

FIG. 4 illustrates a configuration of a surprise money box with a pair of flaps in a closed configuration where the flaps are parallel and coincident to each other and perpendicular to sides of the box.

FIG. 5 illustrates an embodiment of a shooter system that can be loaded with a plurality of bills by opening a loading door on a side of the shooter system to expose a bill cavity that comprises a roller.

FIG. 6 illustrates an embodiment of a shooter system where a plurality of bills can be loaded into the bill cavity and the loading door can be closed over the loaded bills.

FIG. 7 illustrates a top view of a roller actuation assembly of a shooter system.

FIG. 8 illustrates a side view of a roller actuation assembly of a shooter system.

FIG. 9 illustrates a perspective view of a roller actuation assembly of a shooter system.

FIG. 10 illustrates a cross-sectional side view of an example of a surprise money box in accordance with an embodiment.

FIG. 11 illustrates an example embodiment of a surprise money box wherein an internal box and shooter system are removable from a body of the surprise money box.

FIG. 12 illustrates a top view of an example shooter system including a slot defined by the top plate that opens to a sheet cavity out of which a stack of a plurality of bills can shoot.

FIG. 13 is an exploded view of a shooter system in accordance with an embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

Some embodiments discussed herein include a gift box that will automatically shoot sheets of paper up into the air when the box is opened. Such sheets of paper can include paper printed to look like fake play money, real currency or other suitable sheets. Along with a money-shooter device inside the box, the box can further include a cavity in which various gift items can be disposed such as candy and a mini cake, or the like.

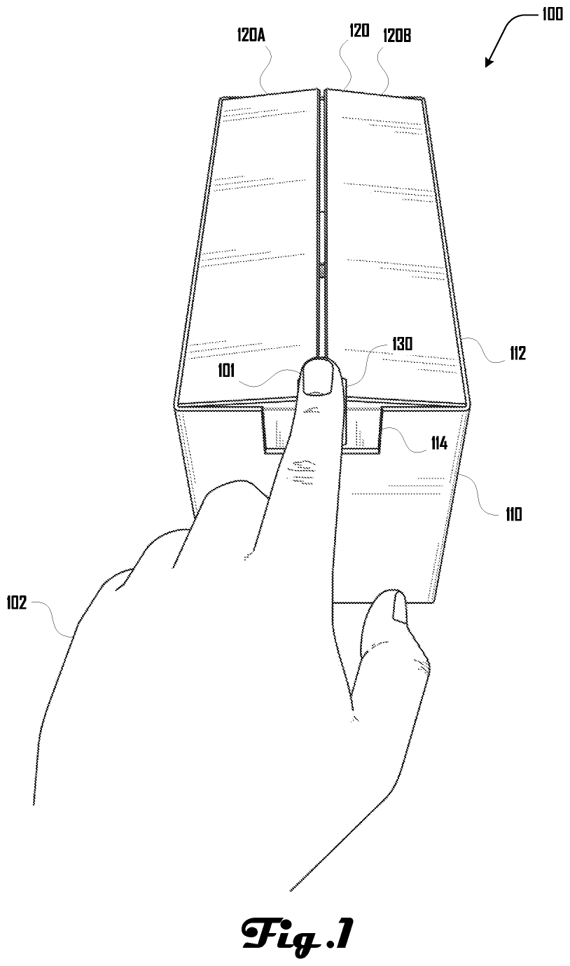

Turning to FIGS. 1-3, an example of operating a surprise money box 100 is illustrated. FIG. 1 illustrates the box 100 in a first configuration after a user 102 presses an actuating button 130 with their finger 101. In this example of FIG. 1, the box 100 is shown having a body 110 with a pair of flaps 120 that are rotatably coupled to a top end 112 of the box 100 at opposing parallel side edges. In various embodiments, the first and second flaps 120A, 120B can be biased (e.g., via springs or the like) toward an open position as discussed in more detail herein and physically held shut via the actuating button 130. FIG. 1 illustrates an example configuration of the box 100 where the actuating button 130 has just released the flaps 120 and they are just beginning to rotate upward and outward via biasing of the flaps 120.

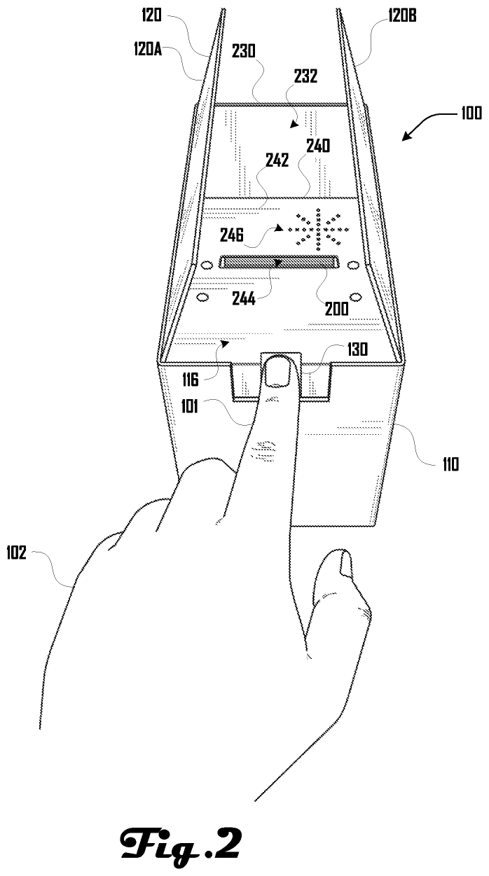

FIG. 2 illustrates the surprise money box 100 in a second configuration after the user 102 has actuated the actuating button 130 where the pair of flaps 120A, 120B on the top of the surprise money box 100 rotate upward to expose an internal body cavity 116 of the surprise money box 100 that includes an internal box 230 and a shooter system 240. The internal box 230 can be a cuboid box in various embodiments that defines an internal box cavity 232. The shooter system 240 can comprise a top plate 242 that defines a slot 244 and a speaker port array 246.

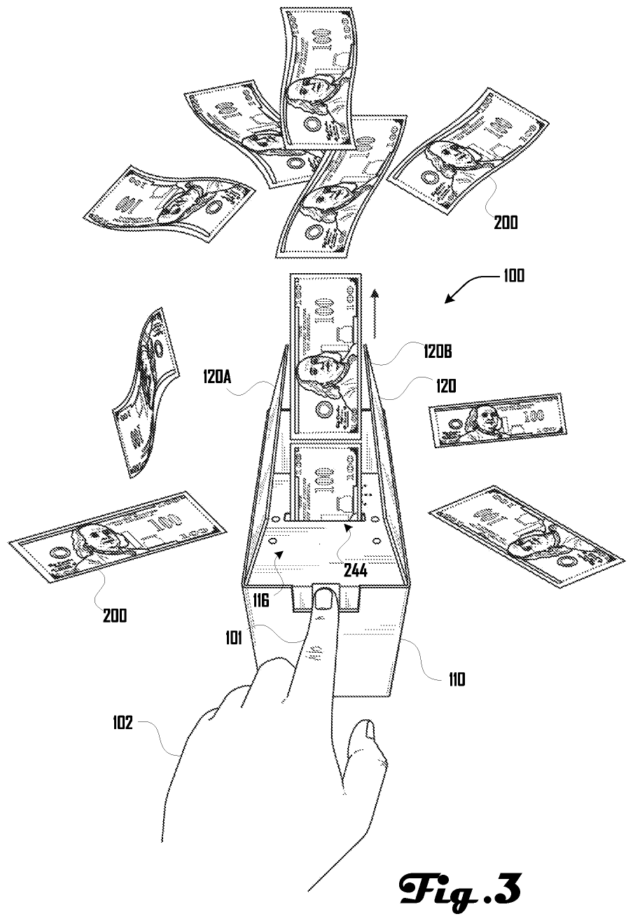

FIG. 3 illustrates a third configuration of the surprise money box 100 after the user 102 has actuated the actuating button 130 where the shooter system 240 has been actuated via the actuating button 130, which causes a plurality of bills 200 loaded in the shooter system 240 to shoot out of the shooter system 240 through the slot 244, between the open flaps 120, and into the air above the surprise money box 100, where the bills 200 can then flutter down to the ground or other surface where the surprise money box 100 is located. In various embodiments, actuation of the shooter system 240 via the actuating button 130 can further include audio output, haptic output, visual output, or the like.

For example, in some embodiments, the song “For The Love of Money” by the O'Jays can be played when the shooter system 240 is actuated (e.g., via a speaker and through the speaker port array 246). In further examples, actuation of the shooter system 240 can comprise flashing lights, vibration, or the like.

In various embodiments, the bills 200 can include real paper currency, replica paper currency, or other suitable planer element, which may or may not be designed to imitate paper currency. Such real or replica currency can include currency from any suitable country and can be of any suitable denomination. In some embodiments, such sheets or bills 200 can comprise paper, with one example including colored paper in a variety of colors which can be designed to look like confetti and another example can include sheets that are a successive gradient of colored paper so as the sheets successively shoot out, they are successively changing along a color gradient. In some examples, bills or sheets can be colored for various suitable purposes such as based on colors of a sports team, for a baby gender-reveal, or the like. The plurality of sheets or bills 200 can all be the same in some examples or may be different in some examples. Any suitable number of sheets or bills 200 can be configured to be ejected from the shooter system 240, including 1, 2, 3, 4, 5, 6, 7, 8, 9, 10, 15, 20, 25, 30, 35, 40, 45, 50, 75, 100, 200, or the like or a range between such example values. While some examples include rectangular sheets or bills 200, further embodiments can include sheets or bills 200 of any suitable shape.

In various embodiments, actuation of the shooter system 240 can cause all of the bills 200 loaded into the shooter system 240 to be ejected rapidly at a constant rate; however, in some examples, the rate of ejection of bills 200 can change, can cease one or more times, or may be configured to only eject a portion of bills 200 loaded in the shooter system 240. In various embodiments, the bills 200 can be ejected constantly at an angle that is generally perpendicular to the top plate 242 of the shooter system 240; however, in further embodiments, the bills 200 can be ejected at any suitable angle, with some examples including changing angle of ejection.

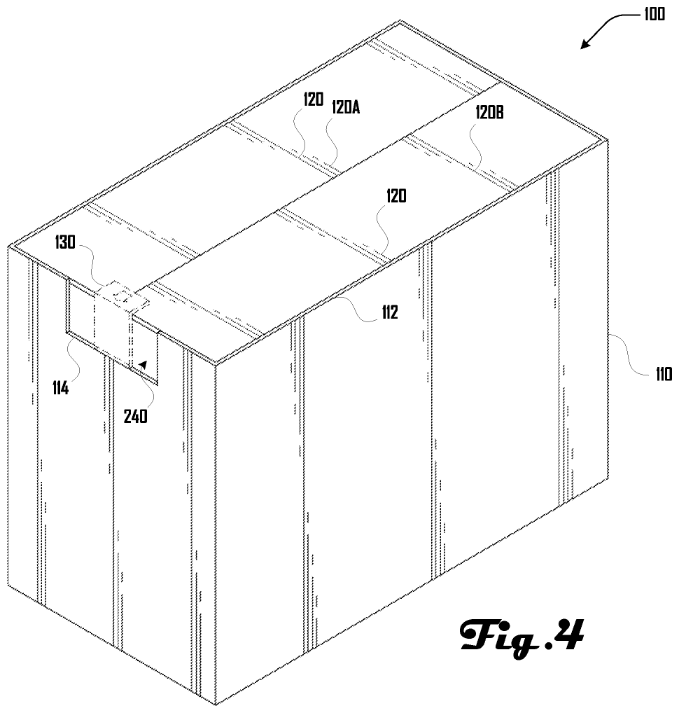

As shown in the example of FIG. 4, the pair of flaps 120 in a closed configuration of the box 100 can be parallel and coincident to each other and parallel to the face of the top plate 242 of the shooter system 240 and perpendicular to sides of the box 100. As shown in the examples of FIGS. 2 and 3, the pair of flaps 120 can open from the closed configuration to an angled configuration relative to the top plate 242 of the shooter system 240. In various examples, the flaps can be configured to open to an angle of 30°, 35°, 40°, 45°, 50°, 55°, 60°, 65°, 70°, 75°, 80°, 85°, 90°, 95°, 100°, 105°, 110°, 115°, 120°, 125°, 130°, 135°, 140°, 145°, 150°, 155°, 160°, 165°, 170°, 175°, 180°, 185°, 190°, 195°, 200°, 205°, 210°, 215°, or the like, or a range between such example values.

In various embodiments, the flaps 120 can be configured to open a sufficient amount to generate an opening that is greater than or equal to the width of the bills 200 being ejected, which can be desirable for allowing the bills 200 to be ejected from the box without hitting the flaps 120.

The flaps 120 can be coupled to the sides of the box 100 in various suitable ways, including a living hinge, or other suitable structure. Such a hinge can cause the flaps 120 to be biased toward an open position such that when the flaps 120 are released (e.g., physically released) by the actuating button 130, the flaps 120 naturally flip upward to the open configuration. However, the flaps 120 can be biased in various suitable ways such as via a spring (e.g., torsion spring, coil spring, leaf spring), or the like, or can be moved to the open configuration in various other suitable ways such as via a piston, motor, or the like.

Also, while two flaps 120A, 120B are shown in various examples herein, some examples can include any suitable number of flaps, including 1, 2, 3, 4, 5, 10 or the like. Additionally, in some embodiments, other suitable elements can be configured to movably cover the shooter system 240 such as a sliding member, aperture, or the like.

In various embodiments, the flaps 120 can be configured to fully open before the bills 200 start shooting out, which can be desirable for preventing the flaps 120 from interfering with the bills 200 shooting out of the top of the box 100 between the open flaps 120. For example, in some embodiments, the shooter system 240 does not activate until the actuating button 130 reaches a certain point which can be when a top stopper piece or notch physically holding the flaps 120 is out of the way. Once the stopper or notch is out of the way the flaps 120 of the box 100 can open on their own (e.g., based on torsion springs). In some embodiments, there can be a timer or other delay from when the actuating button 130 is pushed until when the bills 200 start shooting out, which can allow time for the flaps 120 to open up before the bills 200 start shooting out of the shooter system 240. In some embodiments, the flaps 120 can include a mechanism, switch or the like that prevents the shooter system 240 from shooting the bills 200 out until the flaps 120 are in a suitable configuration where the bills 200 will not hit the flaps 120.

Additionally, as shown in FIGS. 1-4, the body 110 of the surprise money box 100 can comprise a notch 114 in a front portion of the body 110 that provides an opening through which the actuating button 130 can extend to be accessible to a user 102 for actuation and to physically hold the flaps 120 closed. In various embodiments, the flaps 120 are only held closed by the actuating button 130.

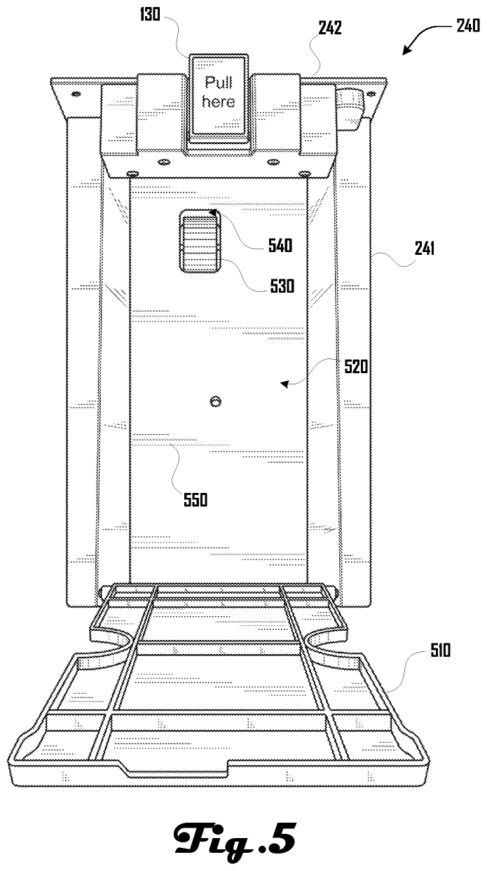

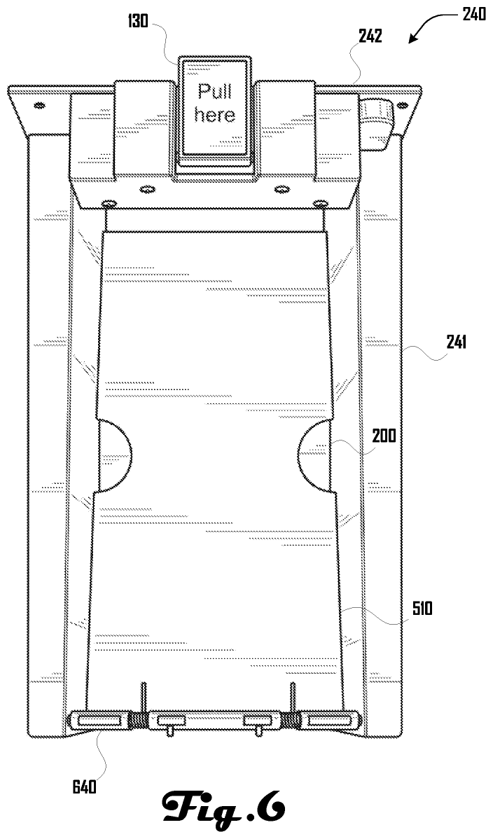

Turning to FIG. 5, in some embodiments the shooter system 240 can comprise a housing 241 that can be loaded with a plurality of bills 200 by opening a loading door 510 on a side of the shooter system 240 to expose a bill cavity 520 defined by the housing 241. A roller 530 can extend through a roller slot 540 defined by a shooter system wall 550 as discussed in more detail herein. As shown in FIG. 6, a plurality of bills 200 can be loaded into the bill cavity 520 defined by the housing 241 and the loading door 510 can be closed over the loaded bills 200. In various embodiments, the loading door 510 can be rotatably coupled to the housing 241 of the shooter system 240 via a hinge 640, with the loading door 510 biased toward the roller 530 (e.g., via a spring) such that as bills 200 are expelled from the shooter system 240, the loading door 510 pushes the remaining bills 200 against roller. In some embodiments, the roller 530 can comprise a traction material to grip the bills 200 better to ensure a constant strong flow of the bills 200 shooting out of the shooter system 240 and box 100.

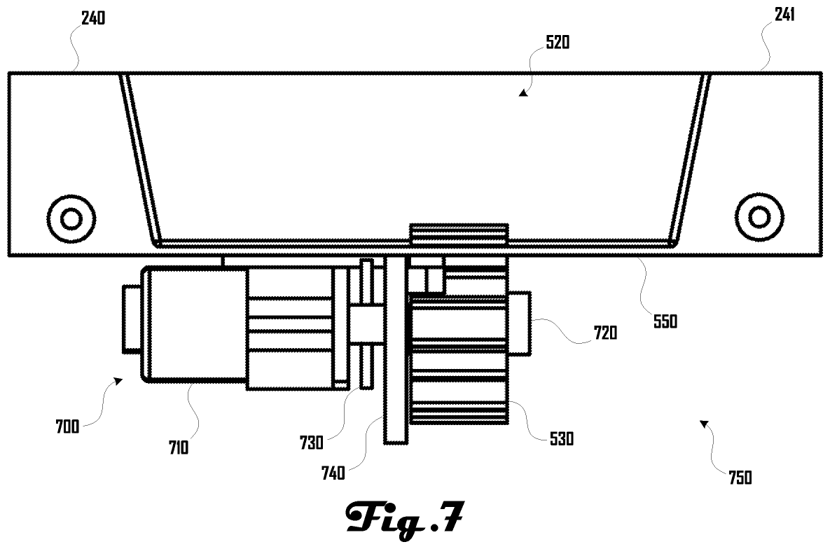

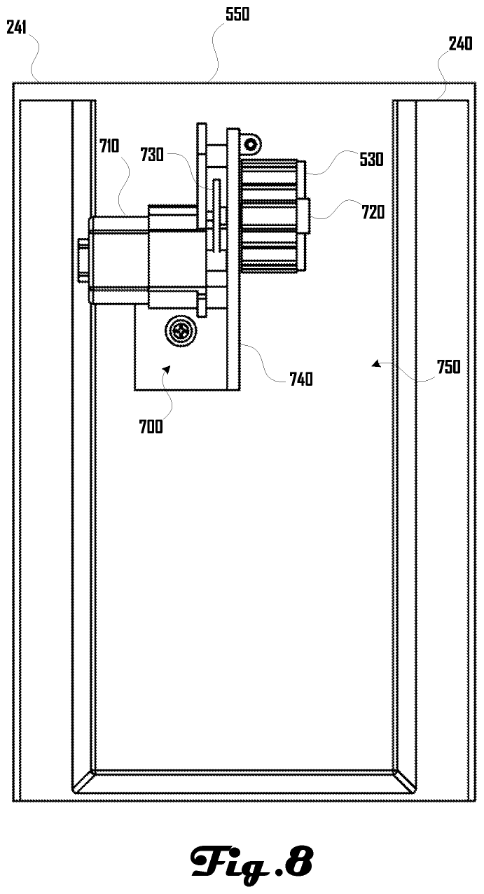

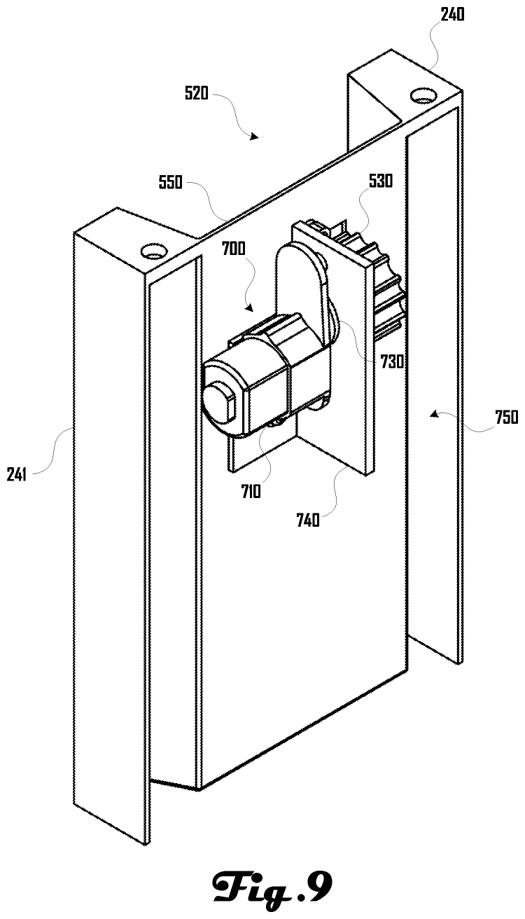

FIGS. 7, 8 and 9 illustrate views of a roller actuation assembly 700 that comprises a motor 710 connected to the roller 530 via an axel 720 and a reduction gear 730. The roller actuation assembly 700 can be coupled to the shooter system wall 550 via a bracket assembly 740 and disposed within a roller actuation assembly cavity 750 defined by the housing 241 of the shooter system 240. The roller 530 can be aligned with the roller slot 540 defined by a shooter system wall 550 such that a portion of the roller 530 extends into the bill cavity 520 to contact one or more bills 200 disposed within the bill cavity 520. In various embodiments, such a portion of the roller 530 that extends into the bill cavity 520 can be less than 1%, 2%, 3%, 4%, 5%, 6%, 7%, 8%, 9%, 10%, 15%, 20%, or the like, or a range between such example values. In various embodiments, activation of the motor 710 can rotate the roller 530 via the axel 720 and a reduction gear 730 to cause one or more bills 200 disposed within the bill cavity 520 to be ejected from the shooter system 240 as discussed herein.

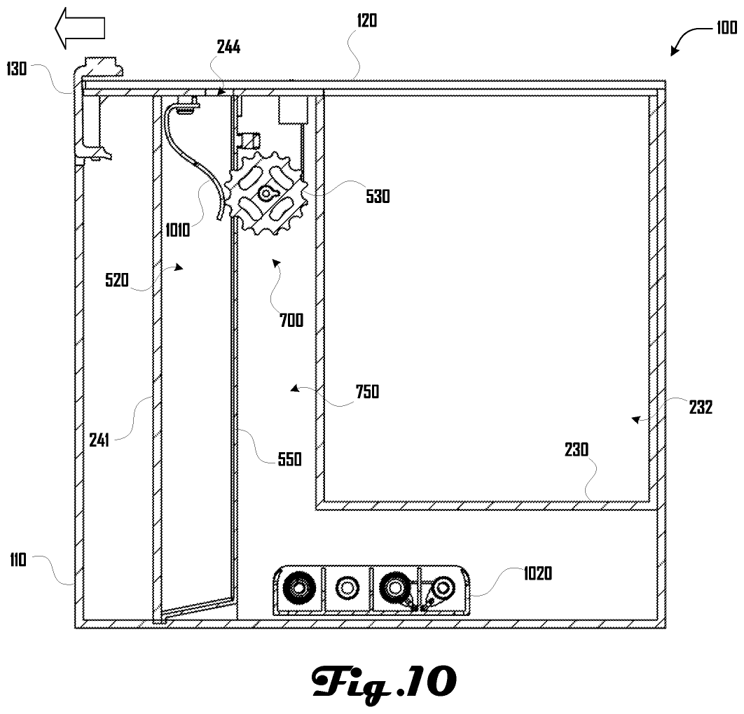

FIG. 10 illustrates a cross-sectional side view of an example of a surprise money box 100 in accordance with an embodiment. The box 100 in this example comprises a roller actuation assembly 700 disposed within a roller actuation assembly cavity 750 with the roller 530 extending through a shooter system wall 550 into a bill cavity 520 defined by the housing 241. In this example, a leaf spring 1010 can be disposed within the bill cavity 520 and can be configured to press against bills 200 disposed within the bill cavity 520 such that the bills 200 are pressed against the roller 530 to facilitate ejecting of the bills 200 out the slot 244 as discussed herein. In further embodiments, various suitable elements can be configured to press bills 200 against one or more rollers 530.

The box 100 in this example can further include a power supply 1020 (e.g., a battery pack) disposed within the roller actuation assembly cavity 750, which can be configured to power various suitable elements of the box 100, such as the motor 710 of the roller actuation assembly 700, a speaker, electronic components (e.g., a printed circuit board (PCB) that hosts and connects such components), or the like.

In various embodiments, pulling the actuating button 130 can trigger rotation of the roller 530 via the motor 710 and/or playing of sound from a speaker in various suitable ways, including via a wired or wireless electric signal that triggers such elements, mechanically via the actuating button 130 actuating one or more switch, or the like. While various embodiments can include a pivoting actuating button 130 that the user 102 can pull to release the flaps 120 and activate the shooter system 240 and/or other elements, further embodiments can include various other suitable actuating mechanisms such as a pull-string, depressible button, turnable knob, switch, latch, or the like. Also, such an element can be various suitable sizes or shapes. Some embodiments can include a plurality of actuating elements.

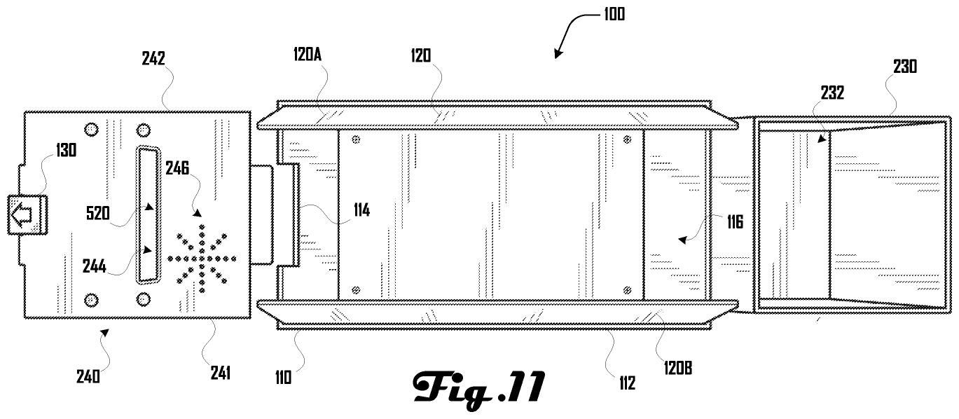

FIG. 11 illustrates an example embodiment of a surprise money box 100 wherein the internal box 230 and shooter system 240 are removable from the body 110 of the surprise money box 100. Such embodiments can be desirable to allow configuration of different versions of a surprise money box 100, which may be customizable by a user 102 buying the surprise money box 100. For example, a customer can specify a certain design of body 110, a certain type of bills 200 or other sheets to be ejected and different objects, foods, or the like that can be present in the internal box 230. For example, where a customer wants to send surprise money box 100 to a friend for a birthday in the United States, the customer can specify a body 110 with a birthday message, US currency of a given denomination to be present in the shooter system 240 and a small birthday cake to be provided in the internal box 230. By having the body 110, internal box 230 and shooter system 240 be modular, this can allow for easy assembly of a customized version of the surprise money box 100 in accordance with user specifications by selecting and combining one of a different pre-made version of the body 110, internal box 230 and shooter system 240 to generate a surprise money box 100 in accordance with user specifications. In some embodiments, themes of the surprise money box 100 can include “Birthday,” “Billionaire,” “Celebration,” “Jackpot,” “Luxe,” “Seasons Greetings,” and the like.

The internal box 230 (e.g., gift box) can be configured to hold various suitable items such as candy, a cake, money, or the like. Additionally, in some embodiments the internal box 230 can comprise an open-top cuboid box as shown in the example of FIG. 11, but in further embodiments, the internal box 230 can have a lid or other suitable cap and can be wrapped like a present in some examples. Accordingly, the specific examples of an internal box 230 should not be construed as being limiting. Additionally, in various embodiments, a surprise money box 100 can comprise, consist essentially of or consist of an internal box 230, a shooter system 240 and a body 110.

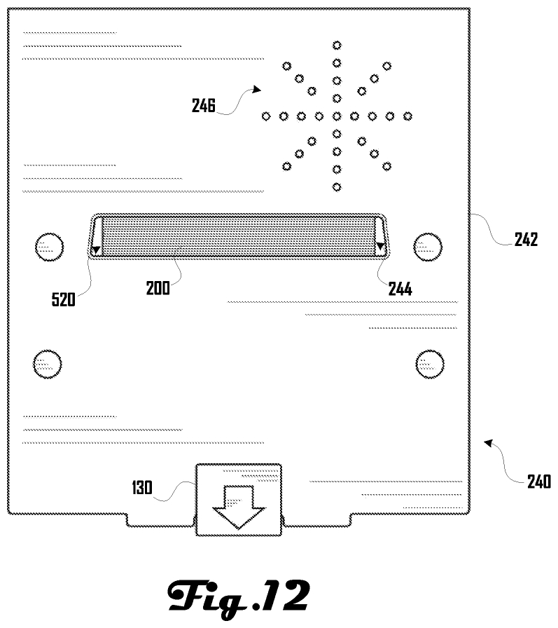

FIG. 12 illustrates a top view of a shooter system 240 including a slot 244 defined by the top plate 242 that opens to a bill cavity 520 out of which a stack of the plurality of bills 200 can sequentially shoot as discussed herein. FIG. 12 also shows holes of a speaker port array 246 which in some embodiments can comprise a plurality of ports defined by the top plate 242 that create a passage between an internal portion of the shooter system 240 where one or more speakers can be disposed (e.g., in a roller actuation assembly cavity 750 defined by the housing 241), with the holes of a speaker port array 246 allowing sound generated by the speaker to emanate from the shooter system 240.

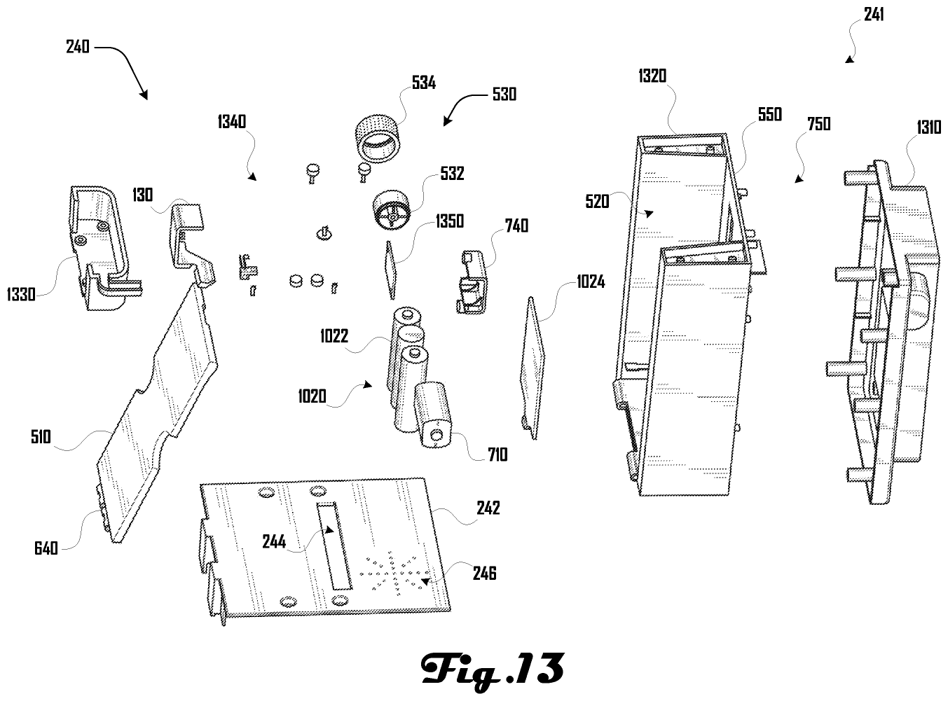

FIG. 13 is an exploded view of a shooter system 240 including the housing 241 including first and second housing portion 1310, 1320 that at least in part define a bill cavity 520 and a roller actuation assembly cavity 750. The shooter system 240 further includes a button cap 1330 that can house components associated with and/or including the button 130. A roller 530 is shown comprising an internal wheel 532 and roller tire 534 that surrounds internal wheel 532 with the roller tire 534 providing a soft (e.g., rubber) body with treads configured to engage bills 200. Also shown is a power supply assembly 1020 that comprises a plurality of batteries (e.g., AA, AAA, or the like) and a battery cap 1024. A plurality of assembly parts 1340 are also shown.

Also shown in FIG. 13 is a control system 1350, which in various embodiments can comprise an electronic component configured to control actions of the surprise money box 100 such as causing the shooter system 240 to eject a plurality of bills 200, play sounds via a speaker, generate output (e.g., light, haptic output), or the like. In various embodiments, the control system 1350 can comprise a printed circuit board (PCB) that hosts, connects and provides power to components such as a microcontroller, microprocessor, memory, and the like.

In some embodiments, electronic components of the surprise money box can exclusively present within or associated with the shooter system 240. For example, in some embodiments, electronic components can be specifically absent from the body 110 and internal box 230.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. A surprise money box, the surprise money box comprising:
a body, the body being a rectangular cuboid box defining an internal body cavity and including first and second flaps that are rotatably coupled to a top end of the body at opposing parallel side edges, the first and second flaps biased toward an open configuration, the body further defining a notch at a front end of the body;
an internal box removably disposed within the internal body cavity of the body, the internal box being a cuboid box defining an internal box cavity; and
a shooter system removably disposed within the internal body cavity of the body, the shooter system comprising:
a housing that defines a bill cavity and a roller actuation assembly cavity, the housing further including a top plate that defines a slot opening to the bill cavity and that defines a speaker port array, the bill cavity and the roller actuation assembly cavity being separated by a shooter system wall that defines a roller slot,
a stack of a plurality of bills disposed within the bill cavity,
a loading door rotatably coupled to the housing via a hinge, with the loading door biased toward, engaging and applying force to the stack of the plurality of bills disposed within the bill cavity,
a roller actuation assembly that comprises a roller and a motor connected to the roller via an axel and a reduction gear, the roller actuation assembly coupled to the shooter system wall via a bracket assembly and disposed within the roller actuation assembly cavity defined by the housing, the roller aligned with the roller slot defined by the shooter system wall such that a portion of the roller extends into the bill cavity and contacts the stack of the plurality of bills disposed within the bill cavity,
a power supply disposed within the housing that includes one or more batteries,
a speaker disposed within the housing,
an electronic control system disposed within the housing and powered by the power supply, the electronic control system configured to control the motor of the roller actuation assembly and control the speaker, and
an actuating button rotatably coupled to the housing and extending through the notch defined by the body, the actuating button directly physically holding both the first and second flaps in a closed configuration and preventing the first and second flaps from rotatably opening to the open configuration based on the biasing of the first and second flaps toward the open configuration,
wherein the actuating button is configured to be rotatably actuated by a finger of a user,
wherein rotatably actuating the actuating button causes the first and second flaps to be physically released from the closed configuration and open to the open configuration based on the biasing of the first and second flaps toward the open configuration,
wherein rotatably actuating the actuating button further causes the electronic control system to play sound from the speaker, and
wherein rotatably actuating the actuating button further causes the electronic control system to activate the motor, which causes the roller to spin, which in turn causes the plurality of stacked bills to be sequentially ejected from the bill cavity through the slot defined by the top plate of the shooter system, the plurality of stacked bills ejected between the first and second flaps in the open configuration and into the air above the surprise money box.

2. The surprise money box of claim 1, wherein rotatably actuating the actuating button causes the electronic control system to play a song from the speaker.

3. The surprise money box of claim 1, wherein the plurality of stacked bills are sheets of rectangular paper that are designed to mimic real paper money currency of at least one country.

4. The surprise money box of claim 1, wherein a cake or candy is disposed within the internal box.

5. A box, the box comprising:
a body, the body being a rectangular cuboid box defining an internal body cavity and including first and second flaps that are rotatably coupled to a top end of the body at opposing parallel side edges, the first and second flaps biased toward an open configuration; and
a shooter system disposed within the internal body cavity of the body, the shooter system comprising:
a housing that defines a sheet cavity and a roller actuation assembly cavity, the housing further including a top plate that defines a slot opening to the sheet cavity, the sheet cavity and the roller actuation assembly cavity being separated by a shooter system wall that defines a roller slot,
a stack of a plurality of sheets disposed within the sheet cavity,
a roller actuation assembly that comprises a roller disposed within the roller actuation assembly cavity defined by the housing, the roller aligned with the roller slot defined by the shooter system wall such that a portion of the roller extends into the sheet cavity and contacts the stack of the plurality of sheets disposed within the sheet cavity,
an electronic control system disposed within the housing configured to control the roller, and
an actuating button physically holding both the first and second flaps in a closed configuration and preventing the first and second flaps from rotatably opening to the open configuration based on the biasing of the first and second flaps toward the open configuration,
wherein rotatably actuating the actuating button causes the first and second flaps to be physically released from the closed configuration and open to the open configuration based on the biasing of the first and second flaps toward the open configuration, and
wherein rotatably actuating the actuating button further causes the electronic control system to spin the roller, which in turn causes the plurality of stacked sheets to be sequentially ejected from the sheet cavity through the slot defined by the top plate of the shooter system, the plurality of stacked sheets ejected between the first and second flaps in the open configuration and into the air above the box.

6. The box of claim 5, wherein the body further defines a notch at a front end of the body, and
wherein the actuating button extends through the notch defined by the body.

7. The box of claim 5, further comprising an internal box that defines an internal box cavity, and
wherein the internal box is removably disposed within the internal body cavity of the body, the internal box being a cuboid box defining the internal box cavity; and
wherein the shooter system is removably disposed within the internal body cavity of the body.

8. The box of claim 5, wherein the plurality of stacked sheets are sheets of rectangular paper that mimic real paper money currency bills of at least one country.

9. The box of claim 5, wherein the roller actuation assembly comprises a motor connected to the roller via an axel, the roller actuation assembly coupled to the shooter system wall via a bracket assembly,
wherein the shooter system further comprises:
a power supply disposed within the housing that includes one or more batteries,
a speaker disposed within the housing,
wherein the electronic control system disposed within the housing is configured to control the motor of the roller actuation assembly and control the speaker,
wherein rotatably actuating the actuating button further causes the electronic control system to play sound from the speaker, and
wherein rotatably actuating the actuating button causes the electronic control system to activate the motor, which causes the roller to spin.

10. A box, the box comprising:
a body, the body defining an internal body cavity and including first and second flaps coupled at a top end of the body; and
a shooter system disposed within the internal body cavity of the body, the shooter system comprising:
a housing that defines a sheet cavity, the housing including a top plate that defines a slot opening to the sheet cavity,
a stack of a plurality of sheets disposed within the sheet cavity,
a roller actuation assembly that comprises a roller that contacts the stack of the plurality of sheets disposed within the sheet cavity, and
an actuating button;
wherein actuating the actuating button causes the first and second flaps to be released from a closed configuration and open to an open configuration, and
wherein actuating the actuating button further causes the roller to spin, which in turn causes the plurality of stacked sheets to be ejected from the sheet cavity through the slot defined by the top plate of the shooter system, the plurality of stacked sheets ejected between the first and second flaps in the open configuration.

11. The box of claim 10, wherein the body of the box is a rectangular cuboid box.

12. The box of claim 10, wherein the first and second flaps are rotatably coupled to a top end of the body at opposing parallel side edges.

13. The box of claim 10, wherein the first and second flaps are biased toward the open configuration.

14. The box of claim 10, wherein the housing defines the sheet cavity and a separate roller actuation assembly cavity.

15. The box of claim 14, wherein the sheet cavity and the roller actuation assembly cavity are separated by a shooter system wall that defines a roller slot.

16. The box of claim 10, wherein the roller actuation assembly is disposed within a roller actuation assembly cavity defined by the housing, and
wherein the roller is aligned with a roller slot defined by the housing such that a portion of the roller extends into the sheet cavity and contacts the stack of the plurality of stacked sheets disposed within the sheet cavity.

17. The box of claim 10 further comprising an electronic control system disposed within the housing configured to control the roller.

18. The box of claim 10, wherein the actuating button physically holds both the first and second flaps in the closed configuration and prevents the first and second flaps from rotatably opening to the open configuration that would otherwise occur based on biasing of the first and second flaps toward the open configuration.

19. The box of claim 10, wherein actuating the actuating button causes the first and second flaps to be physically released from the closed configuration and open to the open configuration based on biasing of the first and second flaps toward the open configuration.

20. The box of claim 10, wherein actuating the actuating button causes an electronic control system to spin the roller, which in turn causes the plurality of stacked sheets to be sequentially ejected from the sheet cavity through the slot defined by the top plate of the shooter system, the plurality of stacked sheets ejected between the first and second flaps in the open configuration and into the air above the box.
